(19) United States
(12) Patent Application Publication
(10) Pub. No.: US 2007/0138668 A1
(43) Pub. Date: Jun. 21, 2007

(54) Process for Extracting Biomedical Devices

(76) Inventors: Yu-Chin Lai, Pittsford, NY (US); Edmond T. Quinn, Rochester, NY (US); Alan C. Wilson, Webster, NY (US)

Correspondence Address: Joseph Barrera;Bausch & Lomb Incorporated, One Bausch & Lomb Place, Rochester, NY, 14604, US

(21) Appl. No.: 11/609,387

(22) Filed: Dec. 12, 2006

Related U.S. Application Data
(60) Provisional application No. 60/752,567, filed on Dec. 21, 2005.

(51) Int. Cl. B29D 11/00

(52) U.S. Cl. 264/1.32; 264/2.6

(57) ABSTRACT

A process for removing extractables from biomedical devices, particularly ophthalmic biomedical devices, involves contacting the device with a mixture of first and second extractants. The first extractant is an organic compound having a flash point above 38° C., and the second extractant is an organic compound having a flash point below 38° C.

This application claims the benefit of Provisional Patent Application No. 60/752,567 filed Dec. 21, 2005 and is incorporated herein by reference.

### FIELD OF THE INVENTION

The present invention relates to a process for extracting polymeric biomedical devices, particularly ophthalmic devices including contact lenses, intraocular lenses and ophthalmic implants.

### BACKGROUND OF THE INVENTION

Hydrogels represent a desirable class of materials for the manufacture of various biomedical devices, including contact lenses. A hydrogel is a hydrated cross-linked polymeric system that contains water in an equilibrium state. Hydrogel lenses offer desirable biocompatibility and comfort.

In a typical process for the manufacture of hydrogel polymeric ophthalmic devices, such as contact lenses, a composition containing a mixture of lens-forming monomers is charged to a mold and cured to polymerize the lens-forming monomers and form a shaped article. This monomer mixture may further include a diluent, in which case the diluent remains in the resulting polymeric article. Additionally, some of these lens-forming monomers may not be fully polymerized, and oligomers may be formed from side reactions of the monomers, these unreacted monomers and oligomers remaining in the polymeric article. Such residual materials may affect optical clarity or irritate the eye when the ophthalmic article is worn or implanted, so generally, the articles are extracted to remove the residual materials. Hydrophilic residual materials can be extracted by water or aqueous solutions, whereas hydrophobic residual materials generally involve extraction with an organic solvent. One common organic solvent is isopropanol, a water-miscible organic solvent. Following extraction, the hydrogel lens article is hydrated by soaking in water or an aqueous solution, which may also serve to replace the organic solvent with water. The molded device can be subjected to machining operations such as lathe cutting, buffing, and polishing, as well as packaging and sterilization procedures.

An example of such a process for silicone hydrogel contact lenses is found in U.S. Pat. No. 5,260,000 (Nandu) et al., where silicone hydrogel contact lenses are cast from monomeric mixtures including n-nonanol or n-hexanol as a diluent, and subsequently extracted with isopropanol to remove any remaining diluent as well as unreacted monomers and oligomers.

Solvents such as isopropanol swell the polymeric device, making them very effective in extracting undesired residual materials from polymeric biomedical devices. However, isopropanol is relatively flammable, having a flash point of 11° C.; additionally, it is relatively expensive to dispose of isopropanol.

The present invention provides a process that employs a mixture of extractants that is less flammable, and therefore, safer for manufacturing processes, yet effective at extracting residual materials from polymeric biomedical devices.

### SUMMARY OF THE INVENTION

This invention provides an improved process for removing extractables from biomedical devices, particularly ophthalmic biomedical devices.

According to a first embodiment, this invention provides a process comprising: removing extractables from a polymeric biomedical device by contacting the device with a mixture of first and second extractants, wherein the first extractant is an organic compound having a flash point above 38° C., and the second extractant is an organic compound having a flash point below 38° C. Suitable polymeric biomedical devices include ophthalmic biomedical devices, especially ophthalmic lenses such as contact lenses. The devices may be composed of a silicone hydrogel copolymer.

The extractables may be removed from the devices by immersing a batch of the devices in the mixture of the first and second extractants. The process may further comprise, following contacting the devices with the mixture of first and second extractants, contacting the devices with water or an aqueous solution, whereby water replaces said mixture of extractants remaining in the devices.

According to various preferred embodiments, the first extractant has a flash point of at least 60° C., more preferably at least 80° C. Additionally, it is preferred the first extractant has a vapor pressure lower than 10 mmHg at 20° C. and/or a boiling point of at least 100° C. at 1 atm. Suitable first extractants include diols, polyols, or ethers thereof, such as diethylene glycol or an ether thereof. Suitable second extractants includes alcohols, such as ethanol or isopropanol.

According to another embodiment, the process comprises: casting a lens-forming monomeric mixture in a mold assembly comprising a contact lens anterior mold section and a contact lens posterior mold section; removing the lens from the mold; and removing extractables from the devices by contacting the devices with said mixture of first and second extractants.

### DETAILED DESCRIPTION OF VARIOUS PREFERRED EMBODIMENTS

The present invention provides a method for removing extractables from biomedical devices, especially ophthalmic biomedical devices. The term “biomedical device” means a device intended for direct contact with living tissue. The term “ophthalmic biomedical device” means a device intended for direct contact with ophthalmic tissue, including contact lenses, intraocular lenses and ophthalmic implants. In the following description, the process is discussed with particular reference to silicone hydrogel contact lenses, a preferred embodiment of this invention, but the invention may be employed for extraction of other polymeric biomedical devices.

Hydrogels comprise a hydrated, crosslinked polymeric system containing water in an equilibrium state. Accordingly, hydrogels are copolymers prepared from hydrophilic monomers. In the case of silicone hydrogels, the hydrogel copolymers are generally prepared by polymerizing a mixture containing at least one lens-forming silicone-containing monomer and at least one lens-forming hydrophilic monomer. Either the silicone-containing monomer or the hydrophilic monomer may function as a crosslinking agent (a crosslinking agent being defined as a monomer having multiple polymerizable functionalities), or alternately, a separate crosslinking agent may be employed in the initial monomer mixture from which the hydrogel copolymer is formed. (As used herein, the term “monomer” or “monomeric” and like terms denote relatively low molecular weight compounds that are polymerizable by free radical polymerization, as well as higher molecular weight compounds also referred to as “prepolymers”, “macromonomers”, and related terms.) Silicone hydrogels typically have a water content between about 10 to about 80 weight percent.

Examples of useful lens-forming hydrophilic monomers include: amides such as N,N-dimethylacrylamide and N,N-dimethylmethacrylamide; cyclic lactams such as N-vinyl-2-pyrrolidone; (meth)acrylated alcohols, such as 2-hydroxyethyl methacrylate, 2-hydroxyethyl acrylate and glyceryl methacrylate; (meth)acrylated poly(ethylene glycol)s; (meth)acrylic acids such as methacrylic acid and acrylic acid; and azlactone-containing monomers, such as 2-isopropenyl-4,4-dimethyl-2-oxazolin-5-one and 2-vinyl-4,4-dimethyl-2-oxazolin-5-one. (As used herein, the term “(meth)” denotes an optional methyl substituent. Thus, terms such as “(meth)acrylate” denotes either methacrylate or acrylate, and “(meth)acrylic acid” denotes either methacrylic acid or acrylic acid.) Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277, the disclosures of which are incorporated herein by reference. Other suitable hydrophilic monomers will be apparent to one skilled in the art.

Applicable silicone-containing monomeric materials for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Examples of applicable silicone-containing monomers include bulky polysiloxanylalkyl(meth)acrylic monomers. An example of such monofunctional, bulky polysiloxanylalkyl(meth)acrylic monomers are represented by the following Formula I:

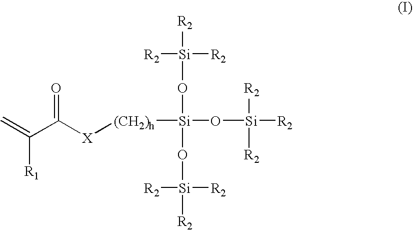

wherein:

X denotes —O— or —NR—;

each R₁ independently denotes hydrogen or methyl;

each R₂ independently denotes a lower alkyl radical, phenyl radical or a group represented by

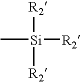

wherein each R₂′ independently denotes a lower alkyl or phenyl radical; and h is 1 to 10. One preferred bulky monomer is 3-methacryloxypropyl tris(trimethyl-siloxy)silane or tris(trimethylsiloxy)silylpropyl methacrylate, sometimes referred to as TRIS.

Another class of representative silicone-containing monomers includes silicone-containing vinyl carbonate or vinyl carbamate monomers such as: 1,3-bis[4-vinyloxycarbonyloxy)but-1-yl]tetramethyldisiloxane; 1,3-bis[4-vinyloxycarbonyloxy)but-1-yl]polydimethylsiloxane; 3-(trimethylsilyl)propyl vinyl carbonate; 3-(vinyloxycarbonylthio)propyl[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

An example of silicone-containing vinyl carbonate or vinyl carbamate monomers are represented by Formula II: 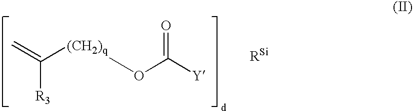
wherein:

Y′ denotes —O—, —S— or —NH—;

R^{Si} denotes a silicone-containing organic radical;

R₃ denotes hydrogen or methyl;

d is 1, 2, 3 or 4; and q is 0 or 1.

Suitable silicone-containing organic radicals R^{Si} include the following: 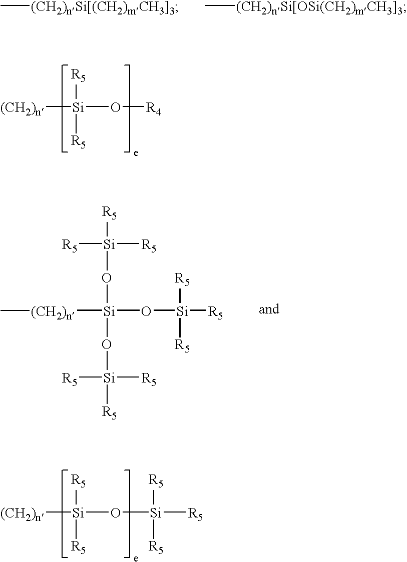
wherein:

R₄ denotes 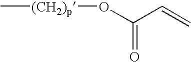
wherein p′ is 1 to 6;

R₅ denotes an alkyl radical or a fluoroalkyl radical having 1 to 6 carbon atoms;

e is 1 to 200; n′ is 1, 2, 3 or 4; and m′ is 0, 1, 2, 3, 4 or 5.

An example of a particular species within Formula II is represented by Formula III:

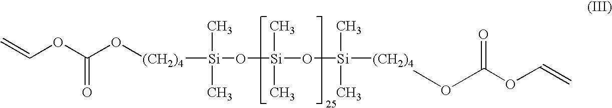

Another class of silicone-containing monomers includes polyurethane-polysiloxane macromonomers (also sometimes referred to as prepolymers), which may have hard-soft-hard blocks like traditional urethane elastomers. Examples of silicone urethane monomers are represented by Formulae IV and V:
E(*D*A*D*G)ₐ*D*A*D*E′; (IV) or
E(*D*G*D*A)ₐ*D*G*D*E′; (V)
wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

a is at least 1;

A denotes a divalent polymeric radical of Formula VI: 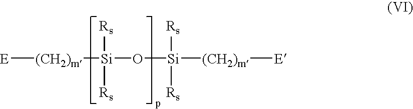
wherein:

each Rₛ independently denotes an alkyl or fluoro-substituted alkyl group having 1 to 10 carbon atoms which may contain ether linkages between carbon atoms;

m′ is at least 1; and

p is a number which provides a moiety weight of 400 to 10,000;

each of E and E′ independently denotes a polymerizable unsaturated organic radical represented by Formula VII: 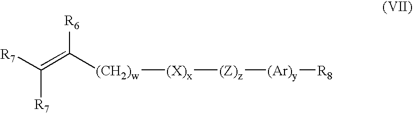
wherein:

R₆ is hydrogen or methyl;

R₇ is hydrogen, an alkyl radical having 1 to 6 carbon atoms, or a —CO—Y—R₉ radical wherein Y is —O—, —S— or —NH—;

R₈ is a divalent alkylene radical having 1 to 10 carbon atoms;

R₉ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; x is 0 or 1; y is 0 or 1; and z is 0 or 1.

A more specific example of a silicone-containing urethane monomer is represented by Formula (VIII):

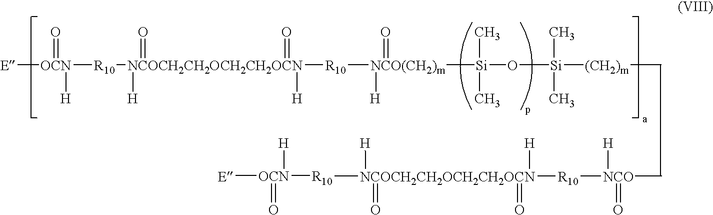

wherein m is at least 1 and is preferably 3 or 4, a is at least 1 and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

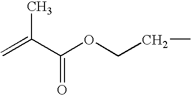

A preferred silicone hydrogel material comprises (based on the initial monomer mixture that is copolymerized to form the hydrogel copolymeric material) 5 to 50 percent, preferably 10 to 25, by weight of one or more silicone macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicone-containing vinyl carbonate or vinyl carbamate or a polyurethane-polysiloxane having one or more hard-soft-hard blocks and end-capped with a hydrophilic monomer.

Specific examples of contact lens materials for which the present invention is useful are taught in U.S. Pat. Nos. 6,891,010 (Kunzler et al.); 5,908,906 (Kunzler et al.); 5,714,557 (Kunzler et al.); 5,710,302 (Kunzler et al.); 5,708,094 (Lai et al.); 5,616,757 (Bambury et al.); 5,610,252 (Bambury et al.); 5,512,205 (Lai); 5,449,729 (Lai); 5,387,662 (Kunzler et al.); 5,310,779 (Lai); and 5,260,000 (Nandu et al.), the disclosures of which are incorporated herein by reference.

Generally, the monomer mixtures may be charged to a mold, and then subjected to heat and/or light radiation, such as UV radiation, to effect curing, or free radical polymerization, of the monomer mixture in the mold. Various processes are known for curing a monomeric mixture in the production of contact lenses or other biomedical devices, including spincasting and static casting. Spincasting methods involve charging the monomer mixture to a mold, and spinning the mold in a controlled manner while exposing the monomer mixture to light. Static casting methods involve charging the monomer mixture between two mold sections forming a mold cavity providing a desired article shape, and curing the monomer mixture by exposure to heat and/or light. In the case of contact lenses, one mold section is shaped to form the anterior lens surface and the other mold section is shaped to form the posterior lens surface. If desired, curing of the monomeric mixture in the mold may be followed by a machining operation in order to provide a contact lens or article having a desired final configuration. Such methods are described in U.S. Pat. Nos. 3,408,429, 3,660,545, 4,113,224, 4,197,266, 5,271,875, and 5,260,000, the disclosures of which are incorporated herein by reference. Additionally, the monomer mixtures may be cast in the shape of rods or buttons, which are then lathe cut into a desired shape, for example, into a lens-shaped article.

As mentioned, an organic diluent may be included in the initial monomeric mixture. As used herein, the term “organic diluent” encompasses organic compounds that are substantially unreactive with the components in the initial mixture, and may be used to minimize incompatibility of the monomeric components in this mixture.

Following casting of the device, the article is extracted to remove undesired extractables from the device. For example, in the case of contact lenses made from a silicone hydrogel copolymer, extractables include any remaining diluent, unreacted monomers, and oligomers formed from side reactions of the monomers.

According to this invention, extractables are removed from the polymeric biomedical device by contacting the device with a mixture of first and second extractants.

The second extractant is an organic compound having a flash point below 38° C. Examples are alcohols, such as ethanol or isopropanol. A main purpose of this second extractant is to swell the article, which in the illustrative example is a contact lens made of a silicone hydrogel copolymer. Preferably, this second extractant has the ability to swell the lens by at least 50 percent by volume if the lens is soaked in the second extractant (without the first extract mixed therewith) for sufficient time that the copolymer reaches equilibrium therewith. The first extractant may also swell the article considerably, but the second extractant will swell the article much more quickly, thus improving the extraction efficiency of the mixture. Stated differently, inclusion of the first extraction in the extraction mixture helps to ensure that extraction is substantially complete and progresses in a shorter time.

The first solvent is an organic compound having a flash point above 38° C., preferably at least 60° C., more preferably at least 80° C., and most preferably at least

It is also preferred that the first extractant has a vapor pressure lower than 10 mmHg at 20° C., and/or a boiling point of at least 100° C. at 1 atm.

Preferably, ratio of the first extractant to the second extractant is 90:10 to 50:50, by weight. The combined extraction mixture has a lower vapor pressure than the second solvent alone, thus rendering the mixture much less flammable than only the second extractant.

For the extraction, the extractable components of the polymeric contact lenses may be removed by contacting the lenses with the mixture of first and second extractants for a period of time sufficient to ensure substantially complete removal of the components. For example, the contact lenses may be immersed in the extracting mixture, for example, at or near ambient temperature (25° C.) and pressure conditions (1 atm). If desired, extraction may be carried out in the receptacles of a contact lens blister package. Generally, the lenses will be rinsed with or soaked in water or aqueous solution following extraction, to replace the extractants with water.

Properties of various organic compounds useful as first or second extractants are listed below.

| | Flash Point | Vapor Pressure |
|---|---|---|
| Compound | (° C.) | (mmHg@25°C.) |
| Isopropanol | 11 | 20.48 |
| Dipropylene glycol | 137 | 0.01 |
| Dipropylene glycol monomethyl ether | 74 | — |
| Diethylene glycol monobutyl ether | 100 | 0.02 |
| Diethylene glycol monopropyl ether | — | 0.06 |
| Diethylene glycol monoethyl ether | 96 | 0.14 |
| Diethylene glycol monomethyl ether | 83 | 0.17 |
| Diethylene glycol monovinyl ether | 82 | 0.06 |
| Hexylene glycol | 93 | 0.04 |
| 2-methyl-butanol | 43 | 16.57 |
| 3-methyl-butanol | 45 | 2.94 |
| 3-pentanol | 40 | — |
| 4-methyl-2-pentanol | 40 | — |
| 2-methoxy-ethanol | 46 | 8.63 |
| 3-methoxy-1-butanol | 46 | 1.07 |

The following examples illustrate various preferred embodiments of this invention. The following abbreviations are used in the illustrative examples.
ID2S4H—a polyurethane-based prepolymer endcapped with 2-methacryloxyethyl (derived from isophorone diisocyanate, diethylene glycol, a polydimethylsiloxanediol, and 2-hydroxyethyl methacrylate according to U.S. Pat. No. 5,034,561) and described more fully in Synthesis A below.
TRIS—3-methacryloxypropyl tris(trimethylsiloxy)silane
DMA—N,N-dimethylacrylamide
NVP—N-vinyl pyrrolidone
HemaVC—methacryloxyethyl vinyl carbonate
Hema—2-hydroxyethylmethacrylate
IMVT—1,4-bis(4-(2-methacryloxyethyl)phenylamino)anthraquinone (described in U.S. Pat. No. 4,997,897), a blue visibility-tinting agent
UV-Agent—2-(2′hydroxy-5′-methacrylxypropylphenyl)-5-chloro-2H-benzotriazole
Initiator—Vazo 64 thermal initiator
DEGMBE—diethylene glycol monobutyl ether
DEGMME—diethylene glycol monomethyl ether
DPGMME—dipropylene glycol monomethyl ether
   Synthesis A—Preparation of a polydimethylsiloxane-based polyurethane polymer (ID2S4H)

A dry 3-neck, 1000 mL round bottom flask was connected to a nitrogen inlet tube and a reflux condenser linked. Then, isophorone (16.916 g, 0.0761 mole), diethylene glycol (4.038 g, 0.0380 mole), dibutyl tin dilaurate (0.383 g) and 140 mL of methylene chloride were added into the flask all at once and the contents were refluxed. After 16 hours, the amount of isocyanate was determined and decreased to 47.0% by titration. Then α,ω-bis(4-hydroxybutyl)polydimethylsiloxane (102.56 g, 0.02536 mole) was added into the flask. Refluxing was continued for 33 hours, and the amount of isocyanate was decreased to 14.1% of the original by titration. The contents were then cooled to ambient temperature. 2-Hydroxyethyl methacrylate (2.2928 g) and 1,1′-bi-2-phenol (0.0129 g) were then added and the contents were stirred at ambient until isocyanate peak at 2267 cm⁻¹ disappeared from IR spectrum of the product. The solvent was then stripped under reduced pressure to yield the product.

### EXAMPLE 1A—LENS CASTING

A monomer mixture was prepared from the components listed in Table 1. The amounts in Table 1 are parts by weight percent unless otherwise noted. The monomer mixture was placed between anterior and posterior contact lens molds, and thermally cured in a nitrogen-filled oven at 110° C. Following curing, the posterior mold sections were removed, and the contact lenses were released from the anterior mold sections.

TABLE 1

| Component | Parts by Weight |
|---|---|
| ID2S4H | 11 |
| TRIS | 35 |
| DMA | 11 |
| NVP | 40 |
| HemaVC | 0.5 |
| Hema | 5 |
| DEGMBE | 3 |
| IMVT | 150 ppm |
| UV-Agent | 0.5 |
| Initiator | 0.5 |

### EXAMPLE 1B—LENS EXTRACTION

The contact lenses were weighed, and then submersed into 1.2 mL of the solvents listed in Table 2. After the noted period of extraction, the lenses were removed from the solvent and placed in 2 mL deionized water for 30 minutes. The lenses were removed from the water, dried overnight in a vacuum oven at 80° C., and then weighed again. The percentage of weight loss is recorded as percent extractables. For each entry in Table 2, batches of six lenses were tested collectively. The first entry in Table 1 served as a control since extraction in isopropyl alcohol (IPA) for sixteen hours should approach removal of all extractables.

TABLE 2

| Solvent | Extraction Time | % Extractables |
|---|---|---|
| IPA | 16 hours | 5.34 |
| IPA | 60 minutes | 5.05 |
| IPA/Water (50/50) | 60 minutes | 2.48 |
| Water | 60 minutes | 2.46 |
| DEGMBE | 60 minutes | 4.2 |
| DEGMME | 60 minutes | 4.80 |
| DPGMME | 60 minutes | 5.07 |
| DEGMBE/Water (50/50) | 60 minutes | 2.22 |

As seen in Table 2, water alone and the IPA/water mixture did not remove sufficient extractables in 60 minutes. Additionally, the mixture of diethylene glycol monomethyl ether and water did not remove sufficient extractables in 60 minutes. Each of diethylene glycol monobutyl ether, diethylene glycol monomethyl ether and dipropylene glycol monomethyl ether removed sufficient extractables in 60 minutes, indicating that these organic compounds may be mixed with isopropanol as an extracting mixture.

Having thus described the preferred embodiment of the invention, those skilled in the art will appreciate that various modifications, additions, and changes may be made thereto without departing from the spirit and scope of the invention, as set forth in the following claims.

We claim:

1. A process comprising:
removing extractables from a polymeric biomedical device by contacting the device with a mixture of first and second extractants,
the first extractant being an organic compound having a flash point above 38° C., and the second extractant being an organic compound having a flash point below 38° C.

2. The process of claim 1, wherein said second extractant is an alcohol.

3. The process of claim 2, wherein said second extractant is ethanol or isopropanol.

4. The process of claim 1, wherein said second extractant has an ability to swell the article by at least 50 percent when the article is soaked in said first extractant.

5. The process of claim 1, wherein said first extractant has a flash point of at least 60° C.

6. The process of claim 1, wherein said first extractant has a flash point of at least 80° C.

7. The process of claim 1, wherein said first extractant has a flash point of at least 100° C.

8. The process of claim 1, wherein said first extractant has a vapor pressure lower than 10 mmHg at 20° C.

9. The process of claim 1, wherein said first extractant has a boiling point of at least 100° C. at 1 atm.

10. The process of claim 1, wherein said first extractant has a flash point greater than 40° C., a vapor pressure lower than 10 mmHg at 20° C., and a boiling point of at least 100° C. at 1 atm.

11. The process of claim 1, wherein said devices are ophthalmic biomedical devices.

12. The process of claim 11, wherein said devices are ophthalmic lenses.

13. The process of claim 12, wherein said devices are contact lenses.

14. The process of claim 13, wherein the contact lenses are composed of a silicone hydrogel copolymer.

15. The process of claim 14, wherein the contact lenses are composed of a polymerization product of a monomeric mixture comprising a silicone-containing lens-forming monomer, a hydrophilic lens-forming monomer, and a diluent.

16. The process of claim 1, wherein the devices are composed of a silicone hydrogel copolymer.

17. The process of claim 1, wherein extractables are removed from the devices by immersing the devices in said mixture of first and second extractants.

18. The process of claim 1, further comprising, following contacting the devices with said mixture of first and second extractants, contacting said devices with water or an aqueous solution, whereby water replaces said mixture of extractants remaining in the devices.

19. The process of claim 1, wherein said first extractant is a diol, a polyol, or an ether thereof.

20. The process of claim 19, wherein said first extractant is diethylene glycol or an ether thereof.

21. The process of claim 19, wherein said first extractant includes at least one member selected from the group consisting of diethylene glycol monomethyl ether, diethylene glycol monoethyl ether, diethylene glycol monopropyl ether, diethylene glycol monobutyl ether, diethylene glycol monovinyl ether, and 3-methoxy-1-butanol.

22. The process of claim 1, wherein a ratio of the first extractant to the second extractant is 90:10 to 50:50, by weight.

23. The process of claim 1, comprising:
casting a lens-forming monomeric mixture in a mold assembly comprising a contact lens anterior mold section and a contact lens posterior mold section;
removing the lens from the mold; and
removing extractables from the devices by contacting the devices with said mixture of first and second extractants.
